(19) United States
(12) Patent Application Publication
(10) Pub. No.: US 2010/0317240 A1
(43) Pub. Date: Dec. 16, 2010

(54) SPEAKER CONNECTING SEAT

(76) Inventor: Wei-Tang Uen, Kaohsiung (TW)

Correspondence Address: Wei-Tang Uen, 235 Chung - Ho, Box 8-24, Taipei, 235, TW

(21) Appl. No.: 12/485,062

(22) Filed: Jun. 16, 2009

(51) Int. Cl. H01R 13/40

(52) U.S. Cl. 439/733.1

(57) ABSTRACT

A speaker connecting seat comprises a first main body; a second main body which are adjacent to the first main body; the second main body including a first through hole and a second through hole; a bridge hole being formed between the first through hole and the second through hole; a first conductive sheet and a second conductive sheet; a gap corresponding to the bridge hole being formed between the first conductive sheet and the second conductive sheet; a first contact end being extended from the first conductive sheet and a second contact end being extended from the second conductive sheet; the first contact end inserting through the first through hole and the second contact end inserting through the second through hole; and a bridge insertable into the gap; when the bridge is inserted into the gap, an outer edge thereof being in contact with the two conductive sheets.

### FIELD OF THE INVENTION

The present invention relates to speakers, in particular to a speaker connecting seat in that the signal path can be changed easily.

### BACKGROUND OF THE INVENTION

Due to the development of speakers (i. e., trumpets) of electronic A/V (audio/video) devices, a speaker serves to convert electronic signals into audio signals. It is an important elements for audio output. The speaker is not only used in sound boxes, earphones, stereos, communications, multimedia computers, electronic translators, etc., but also used in the devices for audio transmission and conversion. Electronic signals may be processed through a mainframe, such as high pitched voice, low pitched voice, etc., even more variation in audio signals. Thus terminals and connectors are used to guide audio signals from different mainframes to the same speaker.

With reference to FIG. 1, if the speaker is desired to have many audio output terminals, it is often that more connectors 2 are necessary, but this induces that the work for assembly is tedious and the cost is high. Furthermore, the outlook is not preferred. The terminals includes positive/negative terminals (22), (21). A plurality of terminals must be connected by a plurality of signal wires (23) by jumping method, but this will increase the amount of signals to be transferred and the resistance in transmission. As a result, the quality of sound is distorted and thus deteriorated. Furthermore, the plurality of wires 23 will induce that the wires are disorder so as to affect the appearance of the stereo.

### SUMMARY OF THE INVENTION

The object of the present invention is to provide a speaker connecting seat comprising a first main body; a second main body which are adjacent to the first main body; the second main body including a first through hole and a second through hole; a bridge hole being formed between the first through hole and the second through hole; a first conductive sheet and a second conductive sheet; a gap corresponding to the bridge hole being formed between the first conductive sheet and the second conductive sheet; a first contact end being extended from the first conductive sheet and a second contact end being extended from the second conductive sheet; the first contact end inserting through the first through hole and the second contact end inserting through the second through hole so as to extend from a front side of the main body to a rear side of the main body; and a bridge insertable into the gap; when the bridge is inserted into the gap, an outer edge thereof being in contact with the first conductive sheet and the second conductive sheet.

In the present invention, by the bridge easily inserting into the gap, the bridge will contact the first conductive sheet and the second conductive sheet so as to have the affect of conduction. The signal is more apparent and the outer appearance of the stereo is beautified.

The various objects and advantages of the present invention will be more readily understood from the following detailed description when read in conjunction with the appended drawing.

### BRIEF DESCRIPTION OF THE DRAWINGS

FIG. 1 is a perspective view of the prior art structure.

FIG. 2 is a perspective view of the present invention.

FIG. 3 is an exploded perspective view showing the main body of the present invention.

FIG. 4 is a plane schematic view about the assembly of the structure illustrated in FIG. 3.

FIG. 5 is an exploded perspective view of another embodiment of the present invention.

FIG. 6 is a perspective view of the present invention, where the locking state is not shown.

FIG. 7 is a plane schematic view of the FIG. 5.

FIG. 8 is an exploded view of another embodiment which is induced from the structure disclosed in FIG. 5.

FIG. 9 is an exploded perspective view of another embodiment of the present invention, where a retaining seat is added.

FIG. 10 is a plane schematic view about the assembly of FIG. 9.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

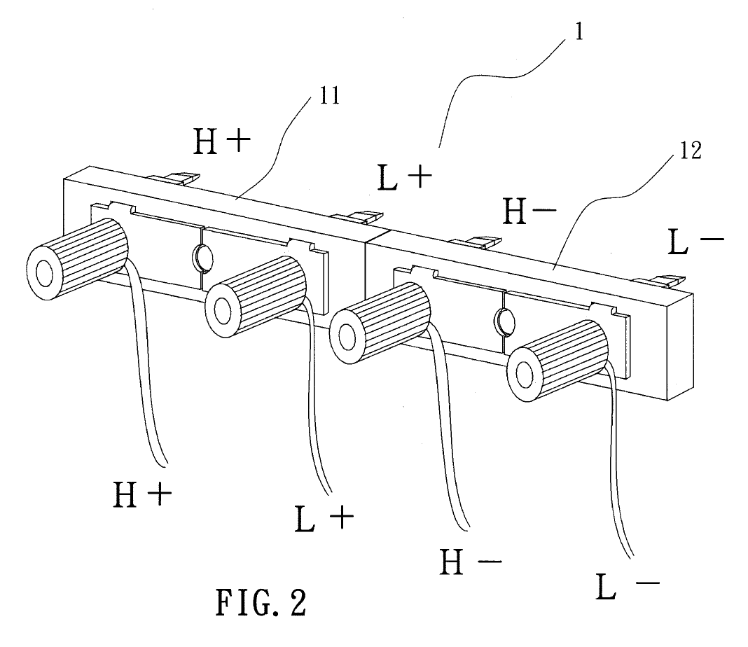

Referring to FIG. 2, the speaker connecting seat 1 of the present invention includes a first main body 11 and a second main body 12 which are adjacent to one another. The first main body 11 is identical to the second main body 12. In the following, the second main body 12 are described, however the first main body 11 is the same as the second main body 12.

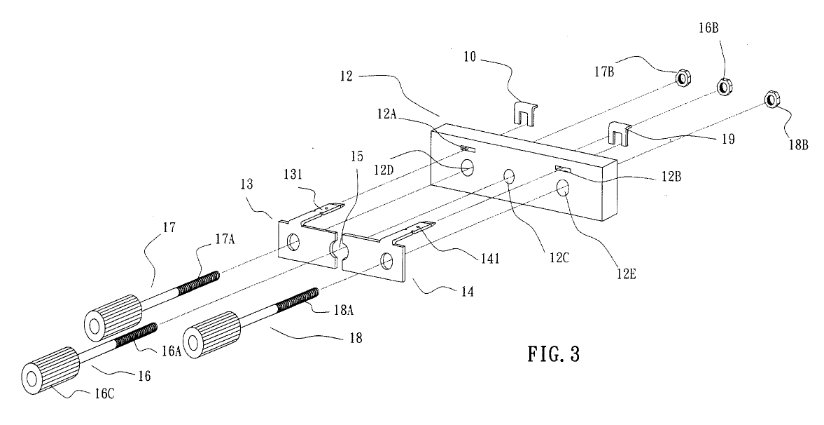

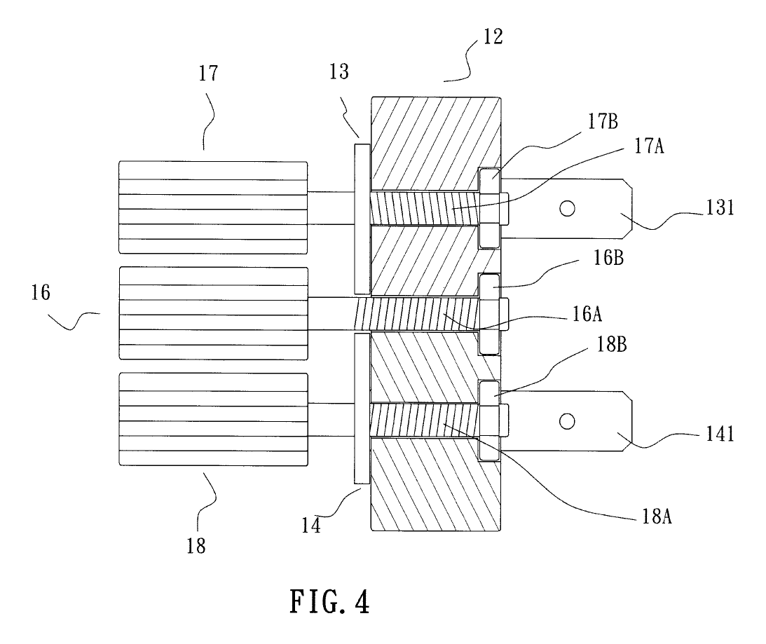

Referring to FIGS. 3 and 4, the second main body 12 has a first through hole 12A and a second through hole 12B which are spaced by a bridge hole 12C. A first conductive sheet 13 and a second conductive sheet 14 are installed on a surface of the second main body 12.

A gap 15 is formed between the first conductive sheet 13 and the second conductive sheet 14. The gap 15 is arranged corresponding to the bridge hole 12C. A first contact end 131 extends from the first conductive sheet 13 and a second contact end 141 extends from the second conductive sheet 14. The first contact end 131 passes through the first through hole 12A and the second contact end 141 passes through the second through hole 12B from a front side of the second main body 12 to the backside of the second main body 12.

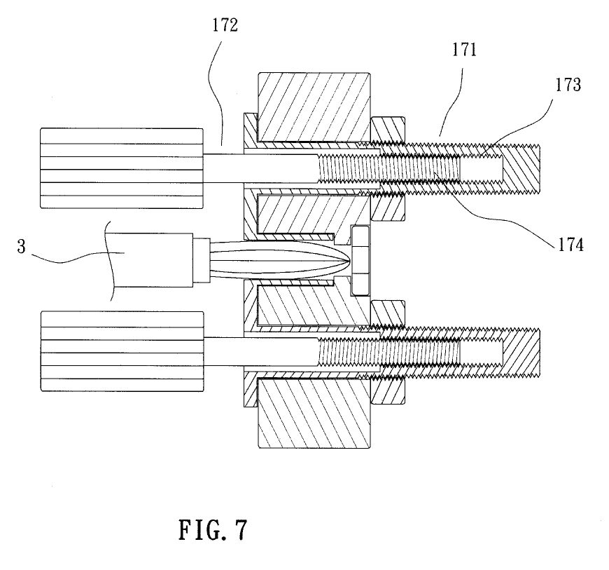

A bridge 16 is a post like terminal (referring to FIG. 7) which can be inserted into the gap 15. When the bridge 16 inserts into the gap 15, an outer edge thereof is in contact with the first conductive sheet 13 and the second conductive sheet 14.

Therefore, in the present invention, the bridge 16 inserts into the gap 15 so as to contact the first conductive sheet 13 and the second conductive sheet 14 to have the effect of conduction. Furthermore, the appearance of the stereo is beautify.

In the present invention, the first contact end 131 and the second contact end 141 have a sheet-like structure. A rear side of the second main body 12 is formed with a first retainer 10 and a second retainer 19 which have a U shape for clamping the first contact end 131 and the second contact end 141 so as to enhance the assembly of the first contact end 131, second contact end 141 and the second main body 12. And thus, the first conductive sheet 13 and the second conductive sheet 14 are not fallen out.

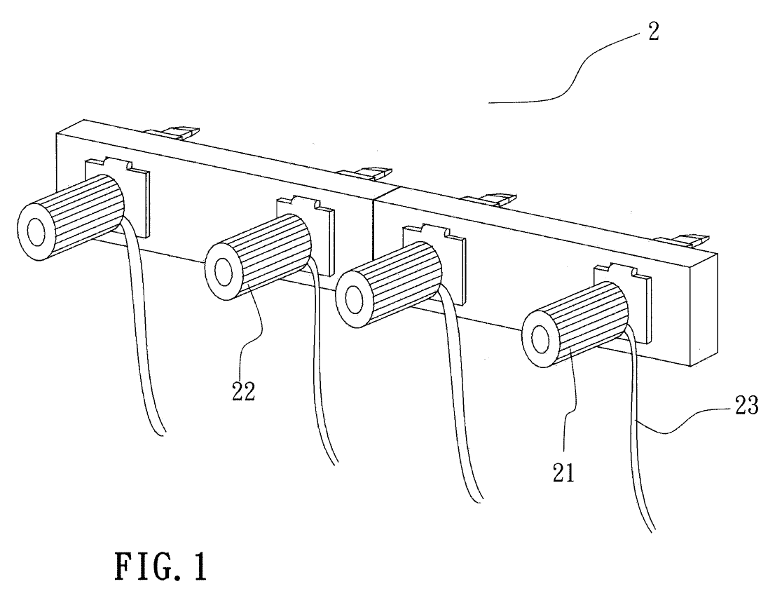

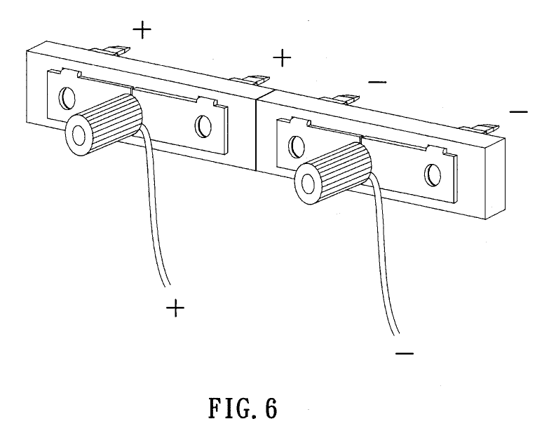

Referring to FIGS. 3 and 4, the second main body 12 is installed with a third through hole 12D and a fourth through hole 12E. A first lock 17 inserts into the third through hole 12D and a second lock 18 inserts into the fourth through hole 12E for adjustment of high pitch and low pitch. Thus those skilled in the art can use the skill of jumping wire to adjust the pitch. Referring to FIG. 6, the user can select a single signal cable. By the bridge 16 to lock the cable to the bridge hole 12C, as illustrated in FIG. 1. The bridge 16 is inserted directly (the bridge 16 can be connected to a cable) so as to conduct the first conductive sheet 13 and the second conductive sheet 14 at the same time. The first lock 17 and the second lock 18 are not used.

Furthermore, the first lock 17, second lock 18 and the bridge 16 have rod-like structure, which are formed with thread sections 17A, 18A and 16A. When they are inserted into the second main body 12, nuts 17B, 18B and 16B are used to fix them so that these components can be firmly secured to the second main body 12. Other than a rod like body, the bridge 16 has an expanded head 16C which can be inserted into the second main body 12. A lateral side thereof can be clamped with a Y shape signal cable (not shown) for other application.

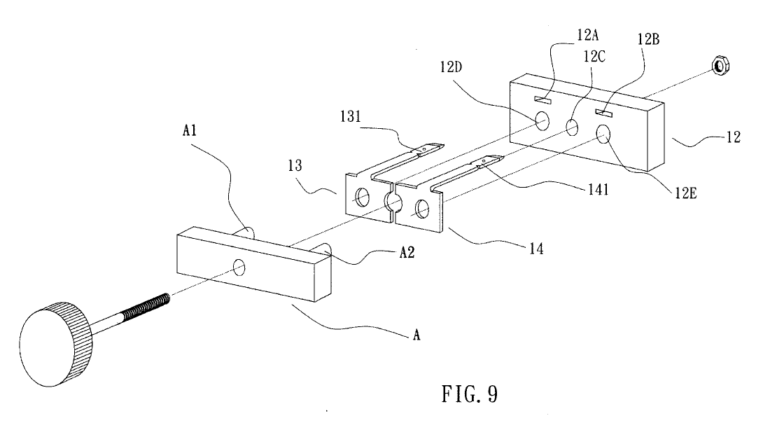

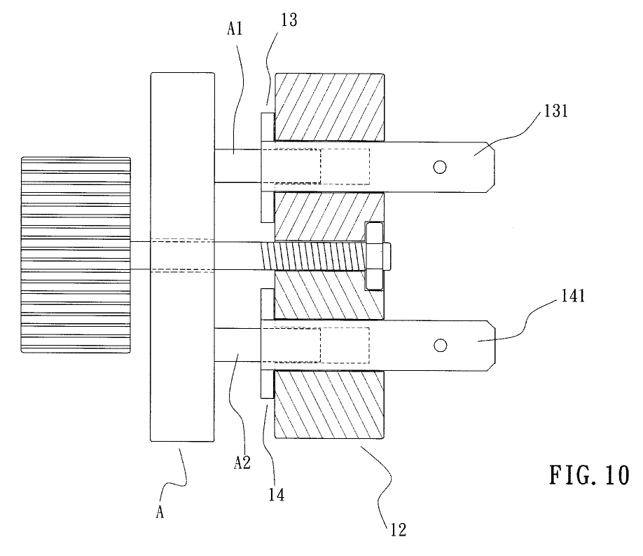

Referring to FIGS. 9 and 10, the second main body 12 of the present invention can be formed with a third through hole 12D and a fourth through hole 12E for retaining two posts A1 and A2 of a retaining seat A so that the third through hole 12D and fourth through hole 12E can conduct the signal wires to the first conductive sheet 13 and second conductive sheet 14 without using the first lock 17 and second lock 18 while the second main body 12 has a flat outer appearance.

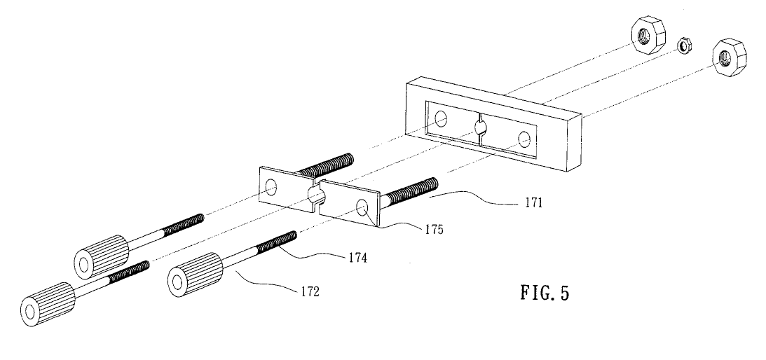

Referring to FIGS. 5 and 7, the first contact end 131 of the first conductive sheet 13 and the second contact end 141 of the second conductive sheet 14 may be a tube structure which has outer thread 133, 143 so as to screw with the nut 134, 144. The bridge 16 may be a post like terminal. When the bridge 16 passes through the gap 15, then it further passes through the bridge hole 12C to screw with nut 162.

Moreover, the first lock 17 and the second lock 18 have outer threads 171, 181. The tube structures of the first contact end 131 and the second contact end 141 have inner thread 143 for screwing with the outer threads 171, 181 which can present an outlook as those of the prior arts.

The first conductive sheet 13 and the second conductive sheet 14 have openings 132, 142 for receiving inserting post like cables so that various signal cables can be installed easily and quickly so that the first lock 17 and the second lock 18 can be assembled quickly. Therefore, the present invention has the functions of retaining cables by locks or directly receiving post like cable. Therefore, various cables can be connected through the present invention.

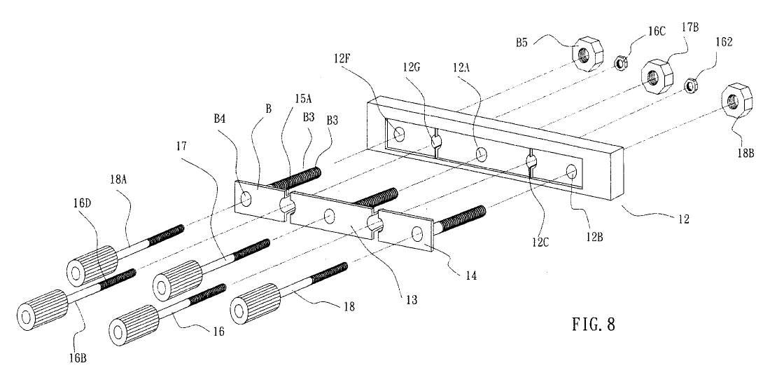

With reference to FIG. 8, the present invention can be expanded from the structures illustrated in FIGS. 5 and 7. The second main body 12 is further installed with a fifth through hole 12F and a second bridge hole 12G. A gap 15A is formed between the first conductive sheet 13 and a third conductive sheet B for receiving a second bridge 16B which may have a rod like structure and has a thread section 16D. The second bridge 16B may be a post like terminal. After the second bridge 16B passes through the gap 15B, it further passes through the bridge hole 12G to screw with the nut 16C and thus to be fixed therein. A third contact sheet B extends from the third conductive sheet B. The third contact sheet B may have a tube like structure. Openings B4 of the tube structure of the third contact sheet B are formed in the third conductive sheet B and the tube structure may have outer thread B3 to be screwed with a nut B5. All such kinds of structures are within the scope of the present invention.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A speaker connecting seat comprising:
a first main body;
a second main body which are adjacent to the first main body;
the second main body including a first through hole and a second through hole; a bridge hole being formed between the first through hole and the second through hole;
a first conductive sheet and a second conductive sheet; a gap corresponding to the bridge hole being formed between the first conductive sheet and the second conductive sheet; a first contact end being extended from the first conductive sheet and a second contact end being extended from the second conductive sheet; the first contact end inserting through the first through hole and the second contact end inserting through the second through hole so as to extend from a front side of the main body to a rear side of the main body; and
a bridge insertable into the gap; when the bridge is inserted into the gap, an outer edge thereof being in contact with the first conductive sheet and the second conductive sheet.

2. The speaker connecting seat as claimed in claim 1, wherein the first contact end and the second contact end have a sheet-like structure; a rear side of the second main body is formed with a first retainer and a second retainer for retaining the first contact end and the second contact end.

3. The speaker connecting seat as claimed in claim 2, wherein each of the first retainer and the second retainer is a U shape buckling structure.

4. The speaker connecting seat as claimed in claim 1, wherein each of the first main body and the second main body is formed with a third through hole and a fourth through hole; a first lock is inserted into the third through hole and a second lock is inserted into the fourth through hole.

5. The speaker connecting seat as claimed in claim 1, wherein the first contact end and the second contact end of the first conductive sheet and the second conductive sheet, respectively, have a tube like structure; each of the first lock and the second lock has outer threads; each of the first contact end and the second contact end has inner threads for receiving the outer threads.

6. The speaker connecting seat as claimed in claim 1, wherein each of the first main body and the second main body is formed with a third through hole and a fourth through hole for receiving two posts of a retaining seat.

7. The speaker connecting seat as claimed in claim 3, wherein the first lock, the second lock and the bridge has a rod like structure having a threaded section; when he first lock, the second lock and the bridge are inserted into the main body, they are screwed with nuts.

8. The speaker connecting seat as claimed in claim 1, wherein the bridge is a post like terminal.
